(19) United States
(12) Patent Application Publication
(10) Pub. No.: US 2016/0086632 A1
(43) Pub. Date: Mar. 24, 2016

(54) AUTOMATED CAPTURE OF IMPAIRED VIDEO

(71) Applicant: ARRIS Enterprises, Inc., Suwanee, GA (US)

(72) Inventor: Victor Scott Shupe, Murfreesboro, TN (US)

(21) Appl. No.: 14/495,377

(22) Filed: Sep. 24, 2014

(51) Int. Cl. G11B 20/18; H04N 21/6543; H04N 21/4147; H04N 21/433; G11B 20/00; H04N 21/234

(52) U.S. Cl. CPC G11B 20/18; G11B 20/00007; H04N 21/23418; H04N 21/4147; H04N 21/4334; H04N 21/6543; H04N 21/4332; G11B 2020/00072

(57) ABSTRACT

Disclosed are a method, system, and apparatus for storing a video segment for analysis is provided. Accordingly, a digital video player receives a digital video, detects a defect in the digital video, and stores a segment of the digital video that contains the defect. The system includes a digital video player that includes a receiver, a decoder coupled to the receiver, and a memory coupled to the decoder. The digital video player optionally comprises a transmitter. The apparatus implements the method for storing a video segment for analysis.

### INTRODUCTION

Digital video can acquire defects in the process of being decoded and displayed to a viewer. This is particularly true when the encoded video is transmitted to the viewer over a network. To be properly viewable, digital video transmitted over a network must ordinarily be transmitted with low delay and a high data rate. Typically, a video stream is encoded and encapsulated in Real Time Protocol (RTP) packets. These packets are commonly transported within the User Datagram Protocol (UDP). Unlike Transmission Control Protocol (TCP), UDP does not provide any retransmission control mechanisms; thus, when video packets are dropped they cannot be recovered. Retransmission, however, can cause unacceptable delays.

Dropped video packets, or corruptions within a packet, can cause defects sufficient to be perceived by a human viewer, who may deem such defects unacceptable. The viewer may desire to contact the content provider to inform the content provider of the defects in the video, and possibly to seek a remedy. The nature of viewable defects is subjective, however, and the viewer may not be able to adequately describe what she is seeing. The content provider would be able to understand and diagnose the defect more easily when the content provider has access to the defective video that the viewer is concerned about.

### SUMMARY

In one embodiment, a method for storing a video segment for analysis is provided. The method comprises receiving, by a digital video player, a digital video; detecting, by the digital video player, a defect in the digital video; and storing, by the digital video player, a segment of the digital video that contains the defect.

In another embodiment a system for storing a video segment for analysis is provide. The system comprises a digital video player. The digital video player comprising a receiver, a decoder coupled to the receiver, and a memory coupled to the decoder. The digital video player is configured to: receive by the receiver a video divided into segments; detect by the decoder a defect in a video segment; and store by the memory the video segment containing the defect. The digital video player optionally comprises a transmitter.

In another embodiment, an apparatus implementing a method for storing a video segment for analysis is provided. The method comprises receiving, by a digital video player, a digital video; detecting, by the digital video player, a defect in the digital video; and storing, by the digital video player, a segment of the digital video that contains the defect.

### FIGURES

The novel features of the embodiments described herein are set forth with particularity in the appended claims. The embodiments, however, both as to organization arid methods of operation may be better understood by reference to the following description, taken in conjunction with the accompanying drawings as follows:

FIG. 1 illustrates one embodiment of a digital video player;

FIG. 2 illustrates one embodiment of a process for detecting and storing a defective segment of a digital video;

FIG. 3 illustrates one embodiment of a process for detecting and storing 306 a defective segment of a digital video, and automatically notifying the content provider that this has occurred;

FIG. 4 illustrates one embodiment of a process for detecting and storing a defective segment of a digital video, and automatically transmitting the defective segment to the content provider;

FIG. 5 illustrates one embodiment of a process in which the viewer detects a defect and initiates a save of a segment of the digital video;

FIG. 6 illustrates one embodiment of a process in which the viewer detects a defect and initiates a save of a segment of the digital video, and the digital video recorder automatically notifies the content provider that this has occurred;

FIG. 7 illustrates one embodiment of a process in which the viewer detects a defect and initiates a save of a segment of the digital video, and the digital video recorder automatically transmits the defective segment to the content provider;

FIG. 8 illustrates one embodiment of a process by which a content provider may acquire a segment of digital video containing a defect; and

FIG. 9 illustrates one embodiment of a process by which a content provider may acquire a segment of digital video containing a defect.

### DESCRIPTION

Digital video is typically encoded from raw video, where the encoding process typically produces a compressed digital video file that is much smaller in physical size than the original raw video. A number of video codecs for encoding and decoding video exist, such as for example Alpary, Animation (qtrle), ArithYuv, AVIzlib, CamStudio GZIP/LZO, Dirac lossless, FastCodec, FFV1, H.264 lossless, Huffyuv (or HuffYUV), JPEG 2000 lossless, Lagarith, LOCO, LZO, MSU Lossless Video Codec, PNG, ScreenPressor, SheerVideo, Snow lossless, TechSmith Screen Capture Codec (TSCC), Ut Video, VMNC, YULS, ZMBV (Zip Motion Block Video) Codec, ZRLE used by VNC, Blackmagic codec, Apple Intermediate Codec, Audio Video Standard (AVS), Bink Video, Blackbird FORscene video codec, Cinepak, Dirac, Firebird, H.261 MPEG-1 Part 2 (MPEG-1 Video), H.262/MPEG-2 Part 2 (MPEG-2 Video), H.263, MPEG-4 Part 2 (MPEG-4 Advanced Simple Profile), H.264/MPEG-4 AVC or MPEG-4 Part 10 (MPEG-4 Advanced Video Coding), HEVC, Indeo 3/4/5, OMS Video, On2 Technologies (TrueMotion VP3/VP4, VP5, VP6, VP7, VP8; or TrueMotion S, TrueMotion 2), Pixlet, RealVideo, Snow Wavelet Codec, Sorenson Video, Sorenson Spark, Tarkin, Theora, VC-1 (SMPTE standard, subset of Windows Media Video), VP9 by Google, Windows Media Video (WMV), MJPEG, JPEG 2000 intra frame video codec, Apple ProRes 422/4444, AVC-Intra, DV, VC-2 SMPTE standard (a.k.a. Dirac Pro), VC-3 SMPTE standard, GoPro CineForm, REDCODE RAW, and Grass Valley Codec.

Because digital video is typically compressed, a large amount of digital video data can be stored and/or transported over a network. Digital video storage media include, for example, compact disks formatted for Blue-Ray(TM), DVD, or CD data, video cassette tapes, and digital files stored in computer-readable memory present in a general purpose computer, a gaming console, a handheld device such as a video player, PDA, or smartphone, or a remote server.

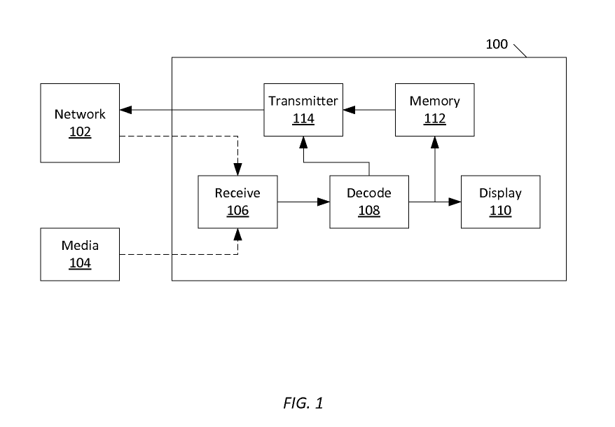

To be viewed, the encoded digital video is decoded by a digital video player. FIG. 1 illustrates one embodiment of a digital video player 100. Digital video players 100 include, for example, Digital Video Recorders (DVR), Blue-Ray™ players, DVD players, CD players, video cassette players, handheld devices such as specialized video players, PDAs, and smartphones, gaming consoles, general purpose computers, and other hardware and/or software devices capable of decoding and displaying video, and any such hardware and/or software built into another device such as a television. The digital video player 100 may receive 106 encoded digital video directly from storage media 104 as described above, or may receive the digital video over a wired or wireless network connection 102 (often referred to as streaming video). A decoder 108 decodes the encoded digital video before it is displayed by a display 110.

In transmitting digital video over a network 102 and/or in decoding the digital video, the decoded video can acquire defects. These defects may not be correctable, either because data has been lost or the decoder has lost synchronization with the video stream, the decoder 108 must discard data in order to recover from the defect, or any combination of these reasons. A single defect or an accumulation of defects may be visible to a human viewer. The defects may affect all or part of the viewable image on the display 110, and can manifest, for example, as pixilation, blockiness, blurriness, noise, and/or other visual distortions, or jerkiness, jumping, freezing, and/or other motion distortions.

A person viewing the video on the display 110 may wish to notify the content provider when the digital video she is viewing shows visible defects. Alternatively or additionally, the video content provider may want to be informed when the video shows defects, so that the content provider can understand and possibly prevent the defects.

A digital video player 100 may be operable to detect that a visible defect has occurred. Upon detecting a defect, the digital video player 100 may be operable to save the segment of the video that contained the defect. The digital video player 100 may be operable to detect the defect automatically. Alternatively or additionally, the viewer may inform the digital video player 100 that she has seen a defect, such as for instance by pushing a button on a remote control in communication with the digital video player 100, or typing commands into a computer or smartphone. The defective video segment may, for example, include several seconds and/or segments-worth of frames before the defective frames and/or several segments-worth of frames after the defective frames. The video segment may be taken from the encoded video stream and/or the decoded video stream. The defective video segment may be saved in a specially designated area in the memory or hard drive of the digital video recorder. The specially designated area may be accessible to the viewer and/or to the content provider by way of a remote connect to the digital video player 100. The specially designated area may additionally or alternatively be secure, such that the area can only be accessed by designated entities or persons, and/or is protected by a password and/or standard encryption method. The digital video player 100 may automatically inform the content provider that a defective video segment has been stored in a computer-readable medium, such as a memory 112 or other digital storage device, for example. Alternatively, or additionally, the digital video player 100 may comprise a transmitter 114 configured to transmit or automatically transmit the defective video segment to the content provider.

A number of methods exist for a digital video recorder to automatically detect that a video has displayed defects. For example, some digital video recorders are able to detect that video data has been lost. As another example, UDP packets contain two Cyclic Redundancy Check (CRC) bytes allowing detection of errors within the packet. When the CRC fails the packet will usually be discarded. As another example, UDP datagrams may be provided with a 16-bit checksum. As another example, some decoders 108 are able to do basic symbol checking and determine that the decoding process has or will lose synchronization with the incoming data stream. Other methods exist, and the embodiments herein are not limited in this context.

Certain embodiments will now be described to provide an overall understanding of the principles of the structure, function, manufacture, and use of the devices and methods disclosed herein. One or more examples of these embodiments are illustrated in the accompanying drawings. Those of ordinary skill in the art will understand that the devices and methods specifically described herein and illustrated in the accompanying drawings are non-limiting exemplary embodiments. The features illustrated or described in connection with one exemplary embodiment may be combined with the features of other embodiments. Such modifications and variations are intended to be included within the scope of the present disclosure.

Reference throughout the specification to “various embodiments,” “some embodiments,” “one embodiment,” or “an embodiment”, or the like, means that a particular feature, structure, or characteristic described in connection with the embodiment is included in at least one embodiment. Thus, appearances of the phrases “in various embodiments,” “in some embodiments,” “in one embodiment”, or “in an embodiment”, or the like, in places throughout the specification are not necessarily all referring to the same embodiment. Furthermore, the particular features, structures, or characteristics may be combined in any suitable manner in one or more embodiments. Thus, the particular features, structures, or characteristics illustrated or described in connection with one embodiment may be combined, in whole or in part, with the features structures, or characteristics of one or more other embodiments without limitation. Such modifications and variations are intended to be included within the scope of the present disclosure.

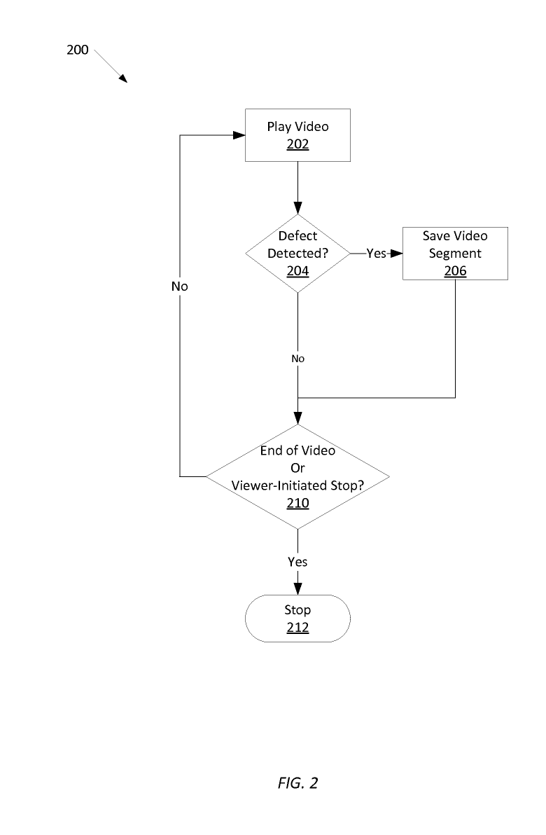

FIG. 2 illustrates one embodiment of a process 200 for detecting 204 and storing 206 a defective segment of a digital video. With reference now to FIGS. 1 and 2, in this process 200, a digital video player 100 plays 202 a video. In some embodiments, the digital video player 100 may automatically detect 204 that a defect has occurred in the display of the video, Upon detecting 204 the defect, the digital video player 100 may save 206 the video segment that contained the defect. The digital video player 100 may then determine 210 whether the end of the video has been reached, or the viewer has stopped the display of the video. When neither is the case, the digital video player 100 will continue to play the video 202. When one or the other is the case, the digital video player will stop 212.

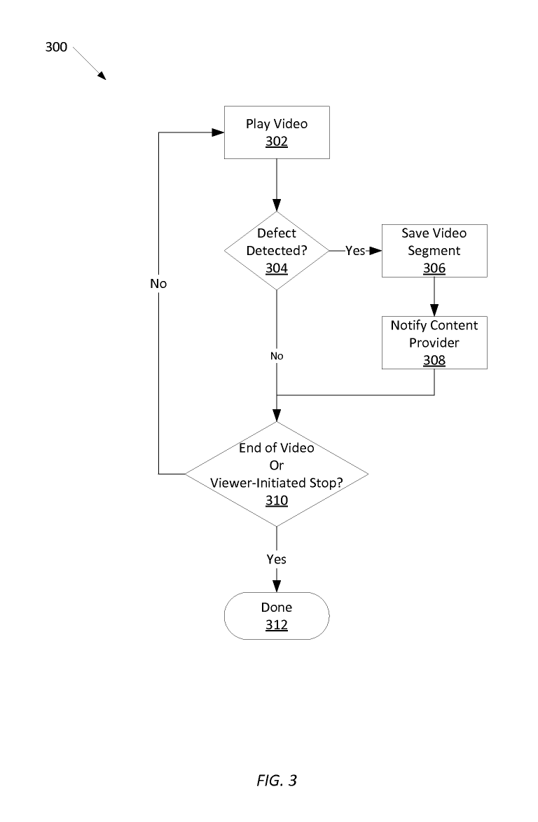

FIG. 3 illustrates one embodiment of a process 300 for detecting 304 and storing 306 a defective segment of a digital video, and automatically notifying 308 the content provider that this has occurred. With reference now to FIGS. 1 and 3, in this process 300, a digital video player 100 plays 302 a video. In some embodiments, the digital video player 100 may automatically detect 304 that a defect has occurred in the display of the video. Upon detecting 304 the defect, the digital video player 100 may save 306 the video segment that contained the defect. The digital video player 100 also may notify 308 the content provider that it has saved 306 a segment of defective video. The digital video player 100 may then determine 310 whether the end of the video has been reached, or the viewer has stopped the display of the video. When neither is the case, the digital video player 100 will continue to play 302 the video. When one or the other is the case, the digital video player 100 will stop 312.

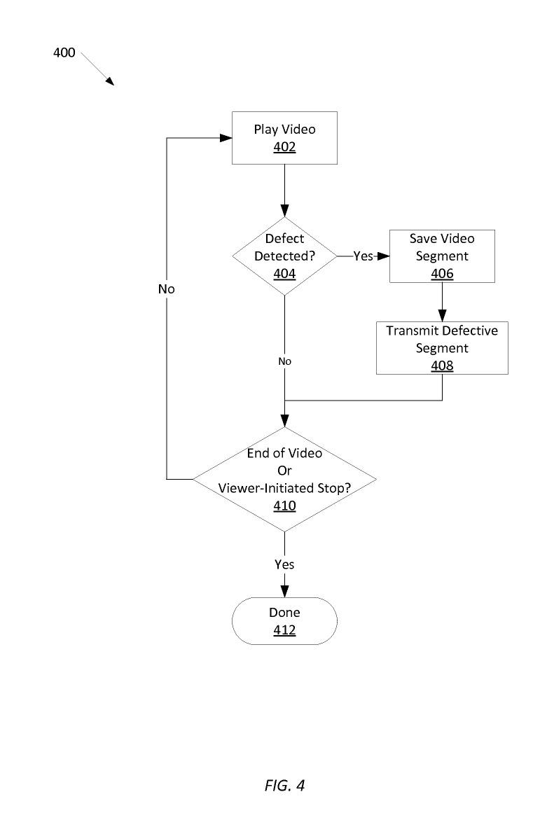

FIG. 4 illustrates one embodiment of a process 400 for detecting 404 and storing 406 a defective segment of a digital video, and automatically transmitting 408 the defective segment to the content provider. With reference now to FIGS. 1 and 4, in this process 400, a digital video player 100 plays 402 a video. In some embodiments, the digital video player 100 may automatically detect 404 that a defect has occurred in the display of the video. Upon detecting 404 the defect, the digital video player 100 may save the video segment 406 that contained the defect. The transmitter 114 portion of the digital video player 100 also may transmit 408 the saved 406 defective video segment to the content provider. The digital video player 100 may then determine 410 whether the end of the video has been reached, or the viewer has stopped the display of the video. When neither is the case, the digital video player 100 will continue to play 402 the video. When one or the other is the case, the digital video 100 player will stop 412.

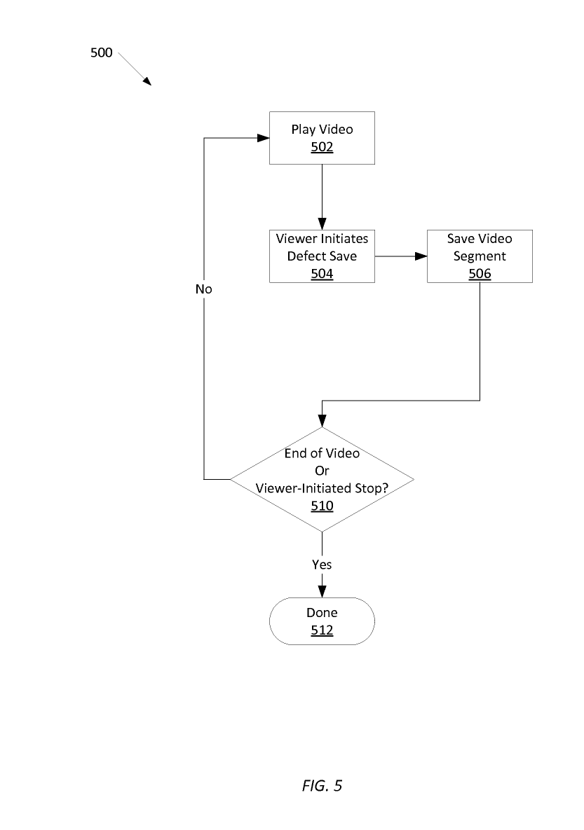

FIG. 5 illustrates one embodiment of a process 500 in which the viewer detects a defect and initiates a save 504 of a segment of the digital video. With reference now to FIGS, 1 and 5, in this process 500, a digital video player 100 plays 502 a video. In some embodiments, the viewer may decide that the displayed video has a defect, and initiate 504 a save of a segment of the digital video. Upon the viewer initiating 504 a save the defect, the digital video player 100 may save 506 the video segment that contained the defect. The digital video player 100 may then determine 510 whether the end of the video has been reached, or the viewer has stopped the display of the video. When neither is the case, the digital video player 100 will continue to play 502 the video. When one or the other is the case, the digital video player 100 will stop 512.

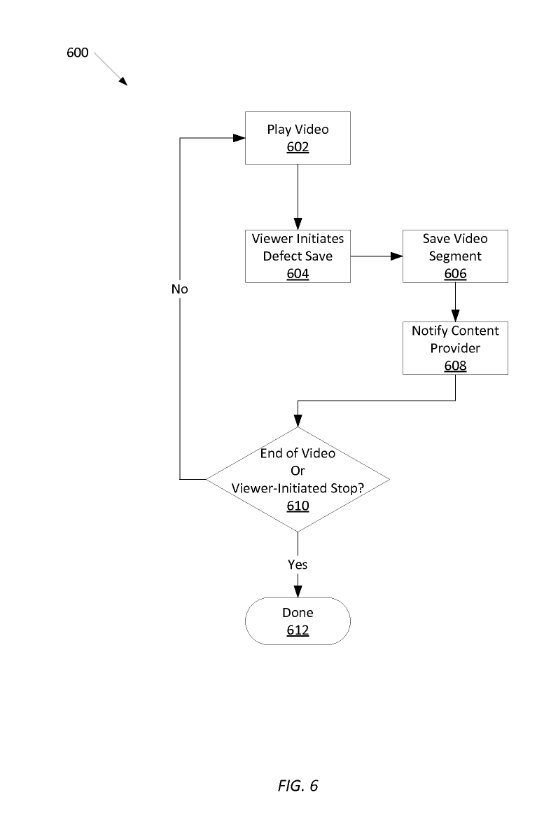

FIG. 6 illustrates one embodiment of a process 600 in which the viewer detects a defect and initiates a save 604 of a segment of the digital video, and a digital video recorder 100 (FIG. 1) automatically notifies 608 the content provider that this has occurred. With reference now to FIGS. 1 and 6, in this process 600, a digital video player 100 plays 602 a video. In some embodiments, the viewer may decide that the displayed video has a defect, arid initiate a save 604 of a segment of the digital video. Upon the viewer initiating a save 604 the defect, the digital video player 100 may save the video segment 606 that contained the defect. The digital video player 100 may also notify the content provider 608 that it has saved 606 a segment of defective video. The digital video player 100 may then determine 610 whether the end of the video has been reached, or the viewer has stopped the display of the video. When neither is the case, the digital video player 100 will continue to play 602 the video. When one or the other is the case, the digital video player 100 will stop 612.

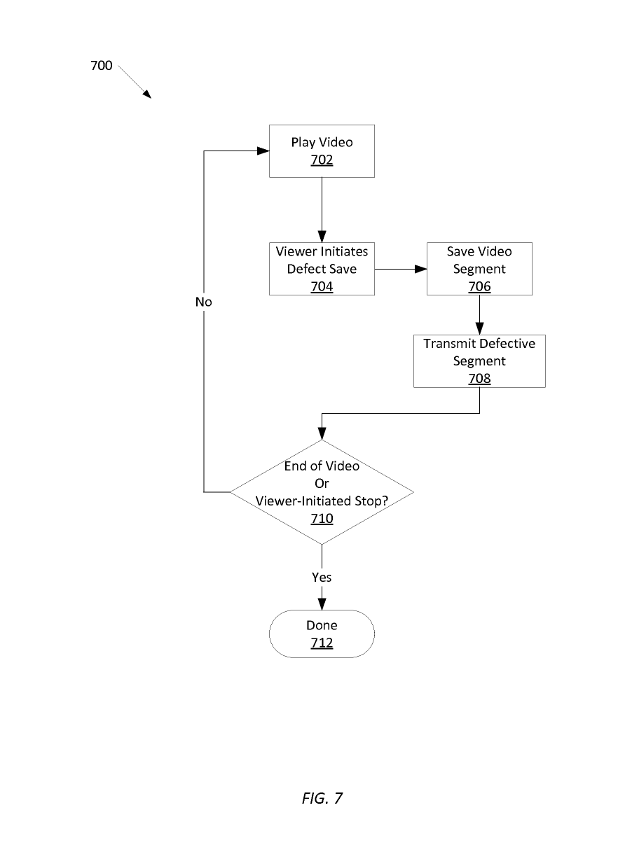

FIG. 7 illustrates one embodiment of a process 700 in which the viewer detects a defect and initiates a save 704 of a segment of the digital video, and the digital video recorder 100 FIG. 1) automatically transmits 708 the defective segment to the content provider. In this process 700, a digital video player plays 702 a video. With reference now to FIGS. 1 and 7, in some embodiments, the viewer may decide that the displayed video has a defect, and initiate 704 a save of a segment of the digital video. Upon the viewer initiating a save 704 the defect, the digital video player 100 may save the video segment 706 that contained the defect. The transmitter 114 portion of the digital video player 100 also may transmit 708 the saved 706 defective video segment the content provider. The digital video player 100 may then determine 710 whether the end of the video has been reached, or the viewer has stopped the display of the video. When neither is the case, the digital video player 100 will continue to play 702 the video. When one or the other is the case, the digital video player 100 will stop 712.

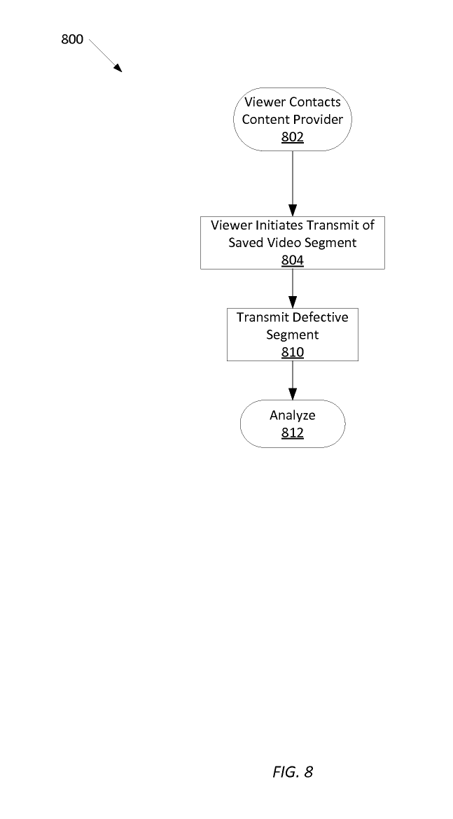

FIG. 8 illustrates one embodiment of a process 800 by which a content provider may acquire a segment of digital video containing a defect. With reference now to FIGS. 1 and 8, in this process 800, the viewer contacts 802 the content provider. In some embodiments, the viewer may then initiate 804 the transmission of a saved video segment. The transmitter 114 portion of the digital video player 100 may then transmit a defective segment 810. The content provider may then be able to analyze 812 the defect.

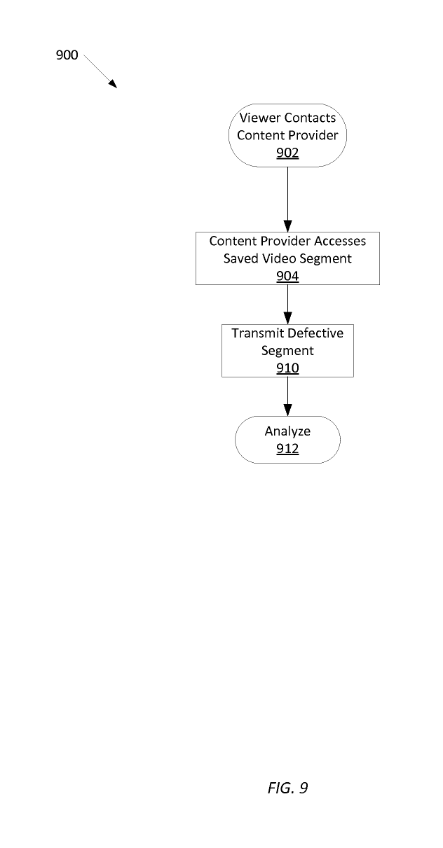

FIG. 9 illustrates one embodiment of a process 900 by which a content provider may acquire a segment of digital video containing a defect. With reference now to FIGS. 1 and 9, in this process 900, the viewer contacts 902 the content provider. In some embodiments, the content provider may then be able to access 904 the saved segment on the digital video player 100. The transmitter portion 114 of the digital video player 100 may then transmit 910 a defective segment. The content provider may then be able to analyze 912 the defect.

It is understood that the above described embodiments are given as examples and not limitations. One skilled in the art will recognized that any and all of the above described embodiments may be combined in a number of different ways.

While various details have been set forth in the foregoing description, it will be appreciated that the various aspects of the systems and methods for automated capture of impaired video may be practiced without these specific details. For example, for conciseness and clarity selected aspects have been shown in block diagram form rather than in detail. Some portions of the detailed descriptions provided herein may be presented in terms of instructions that operate on data that is stored in a computer memory. Such descriptions and representations are used by those skilled in the art to describe and convey the substance of their work to others skilled in the art. In general, an algorithm refers to a self-consistent sequence of steps leading to a desired result, where a “step” refers to a manipulation of physical quantities which may, though need not necessarily, take the form of electrical or magnetic signals capable of being stored, transferred, combined, compared, and otherwise manipulated. It is common usage to refer to these signals as bits, values, elements, symbols, characters, terms, numbers, or the like. These and similar terms may be associated with the appropriate physical quantities and are merely convenient labels applied to these quantities.

Unless specifically stated otherwise as apparent from the foregoing discussion, it is appreciated that, throughout the foregoing description, discussions using terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

It is worthy to note that any reference to “one aspect,” “an aspect,” “one embodiment,” or “an embodiment” means that a particular feature, structure, or characteristic described in connection with the aspect is included in at least one aspect. Thus, appearances of the phrases “in one aspect,” “in an aspect,” “in one embodiment,” or “in an embodiment” in various places throughout the specification are not necessarily all referring to the same aspect. Furthermore, the particular features, structures or characteristics may be combined in any suitable manner in one or more aspects.

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

Some or all of the embodiments described herein may generally comprise technologies for various aspects of the systems and methods for automated capture of impaired video, or otherwise according to technologies described herein, In a general sense, those skilled in the art will recognize that the various aspects described herein which can be implemented, individually, and/or collectively, by a wide range of hardware, software, firmware, or any combination thereof can be viewed as being composed of various types of “electrical circuitry,” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modern, communications switch, or optical-electrical equipment). Those having skill in the art will recognize that the subject matter described herein may be implemented in an analog or digital fashion or some combination thereof.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. Those skilled in the art will recognize, however, that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link (e.g., transmitter, receiver, transmission logic, reception logic, etc.), etc.).

Although various embodiments have been described herein, many modifications, variations, substitutions, changes, and equivalents to those embodiments may be implemented and will occur to those skilled in the art. Also, where materials are disclosed for certain components, other materials may be used. It is therefore to be understood that the foregoing description and the appended claims are intended to cover all such modifications and variations as falling within the scope of the disclosed embodiments. The following claims are intended to cover all such modification and variations.

What is claimed is:

1. A method for storing a video segment for analysis, comprising:
receiving, by a digital video player, a digital video;
detecting, by the digital video player, a defect in the digital video; and
storing, by the digital video player, a segment of the digital video that contains the defect.

2. The method of claim 1, further comprising automatically detecting, by the digital video player, the defect.

3. The method of claim 1, further comprising:
receiving, by the digital video player, a detect defect command; and
detecting, by the digital video player, the defect when it receives the detect command.

4. The method of claim 1, further comprising storing, by digital video player, the video segment in a specified location.

5. The method of claim 1, further comprising transmitting, by the digital video player, the segment for analysis.

6. The method of claim 5, further comprising transmitting, by the digital video player, the segment when it receives a transmit command.

7. The method of claim 5, further comprising:
receiving, by the digital video player, a request defect command; and
sending, by the digital video player, the segment when it receives the request detect command.

8. The method of claim 5, further comprising automatically sending, by the digital video player, the segment.

9. A system for storing a video segment for analysis, the system comprising:
a digital video player, comprising a receiver, a decoder coupled to the receiver, and a memory coupled to the decoder, the digital video player configured to:
receive by the receiver a video divided into segments;
detect by the decoder a defect in a video segment; and
store by the memory the video segment containing the defect.

10. The system of claim 9, wherein the decoder is configured to automatically detect the defect.

11. The system of claim 9, wherein the decoder is configured to detect the defect when it receives a detect command from the receiver.

12. The system of claim 9, wherein the memory digital video player is configured to store the video segment in a specified location of the memory.

13. The system of claim 12, wherein the specified memory location is secure.

14. The system of claim 12, wherein the specified memory location is accessible to a viewer.

15. The system of claim 12, wherein the specified location is accessible to a video content provider.

16. The system of claim 9, wherein the digital video player further comprises a transmitter configured to transmit the segment for analysis.

17. The system of claim 16, wherein the transmitter is configured to transmit the segment when it receives a transmit command.

18. The system of claim 16, wherein the transmitter is configured to transmit the segment when it receives a request command.

19. The system of claim 16, wherein the digital video player is configured to send the segment automatically via the transmitter.

20. An apparatus, comprising a digital video player implementing the method of claim 1.
